(19) United States
(12) Patent Application Publication
(10) Pub. No.: US 2012/0173974 A1
(43) Pub. Date: Jul. 5, 2012

(54) SOCIALIZED HELP FOR COMPUTING APPLICATIONS

(75) Inventors: James S. Taylor, Southampton (GB); Cerys Willoughby, Eastleigh (GB)

(73) Assignee: International Business Machines Corporation, Armonk, NY (US)

(21) Appl. No.: 12/983,045

(22) Filed: Dec. 31, 2010

(51) Int. Cl. G06F 3/00

(52) U.S. Cl. 715/705

(57) ABSTRACT

In an embodiment of the invention, a method for managing socialized help in a networked computing application is provided. The method includes receiving, from a help authoring user in a graphical user interface (GUI) rendered for the help authoring user, a specification of a designated region of the GUI, storing help text authored by the help authoring user in connection with the designated region, detecting a help request by a help consuming user in association with a region of a GUI rendered for the help consuming user and corresponding to the designated region, retrieving the help text authored by the help authoring user in connection with the designated region, and rendering the help text in the GUI rendered for the help consuming user.

### BACKGROUND OF THE INVENTION

1. Field of the Invention

The present invention relates to the field of help processing for computer programs and more particularly to help authoring and distribution for a computer program.

2. Description of the Related Art

Computing applications have always included developer-authored user help, including the rudimentary “read me” document, the more advanced help index accessible from a menu bar, and with the advent of the Web, a direct hyperlink from the computer program to a remote, Web site of help content. Of course, help content always could be found within the user manual of the computer program. Notwithstanding, relying upon help in a user manual is not desirable in as much as the user manual once printed rapidly can become out of date or plain wrong—particularly in the face of continuous product patching, updating, and upgrading of the computer program. Naturally, end users often access help via telephonic or computer messaged service requests to the developer or the company distributing the application. In the latter instance, though, the end user first must engage a costly support agreement.

Help for the computer program has evolved in the age of the Internet to include news groups and information available from the World Wide Web, including help found through Internet searches and online encyclopedias. Information found on newsgroups and on the World Wide Web can be hard to find, however, forcing the end user to consume a lot of time conducting several searches in the attempt to find answers. Also, even if information is located, the information can be wrong or incomplete as the information is often not supported by references. In addition, any information that is found is often generic, not specifically addressing the issue experienced by the end user. User groups and forums can be helpful in this regard as end users often experience the same issues and can publish tips or found solutions to those common problems.

Notwithstanding, to access a user group or forum requires the end user to access a Web site from an application that differs from the computer program giving rise to the help issue. Further, the end user must, at the time of seeking help at the forum, properly articulate the nature of the issue so as to locate any requisite help. To the extent the end user fails to properly articulate the nature of the issue, the end user will not locate the help contributions of others, even if the relevant help contributions exist in the group forum.

### BRIEF SUMMARY OF THE INVENTION

Embodiments of the present invention address deficiencies in the field of managing socialized help for networked computing applications and provide a novel and non-obvious method, data processing system, and computer program product for managed socialized help. In an embodiment of the invention, a method for managing socialized help is provided and includes receiving, from a help authoring user in a graphical user interface (GUI) rendered for the help authoring user in a display, a specification of a designated region of the GUI, storing help text authored by the help authoring user in connection with the designated region, detecting a help request by a help consuming user in association with a region of a GUI rendered for the help consuming user and corresponding to the designated region, retrieving the help text authored by the help authoring user in connection with the designated region, and rendering the help text in the GUI rendered for the help consuming user.

Another embodiment of the invention provides a socialized help management system on a networked computing application. The system can include a host server coupled to a database networked to a client computer configured to support a display, a computing application and a socialized help module. The socialized help module can include program code for receiving, from a help authoring user in a graphical user interface (GUI) rendered for the help authoring user in a display executing on a computing application of a client computer, a specification of a designated region of the GUI, storing help text authored by the help authoring user in connection with the designated region, detecting a help request by a help consuming user in association with a region of a GUI rendered for the help consuming user and corresponding to the designated region, retrieving the help text authored by the help authoring user in connection with the designated region, and rendering the help text in the GUI rendered for the help consuming user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for managing socialized help;

FIG. 2 is a schematic illustration of a networked computing data processing system configured for managing socialized help; and,

FIG. 3 is a flow chart illustrating a process for managing socialized help when socialized help is authored and consumed in a networked computing application.

### DETAILED DESCRIPTION OF THE INVENTION

In accordance with an embodiment of the invention, authored help by a first user, including a title and a body of text, associated with a field of a graphical user interface (GUI) can be received and stored in a database according to the coordinates of the field and/or the values of an area of pixels encompassing the field. The networked computing application can retrieve and render the authored help, associated with the specific field, in response to a detected help request from a second user. In this way, specific, customized authored help associated with a specific field of a GUI can be provided.

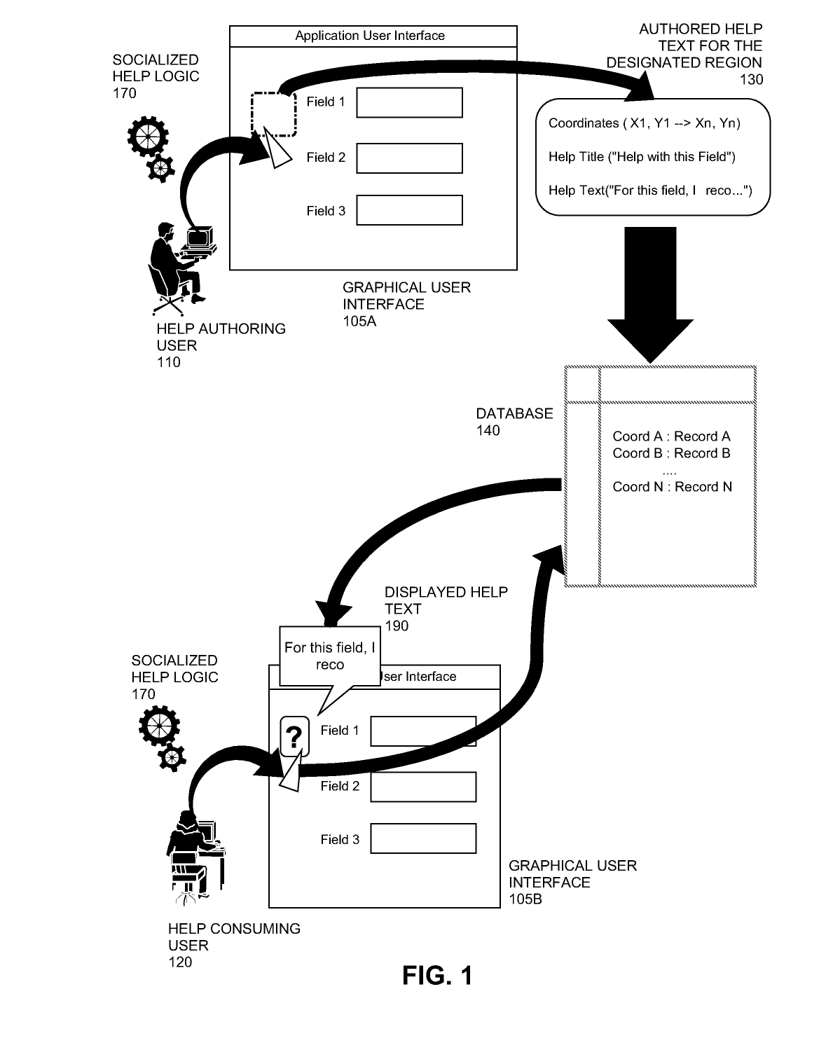

In further illustration, FIG. 1 pictorially shows a process for managing socialized help. As shown in FIG. 1, a help authoring user 110 by way of a client computer accesses a graphical user interface (GUI) 105A from a computing application. The help authoring user 110 subsequently submits authored help text for a designated region 130. The designated region 130 is a region with specific coordinates on a GUI and/or defined by a specific 2 dimensional array of pixels on a GUI. Authored help text 130 can optionally be associated with a specific application or application user interface that the help authoring user 110 submits help text for. Upon receiving the specification from the help authoring user 110, socialized help logic 170 stores the authored help text for the designated region 130 in a database 140.

The specification (or help contribution) is not limited to any specific information, but can include information on the identity of the help authoring user, the designated region the help authoring user is providing help text for, and the computing application the help text is associated with. The authored help text (or help text) can include a help title that may indicate the field that the help references in addition to the body of the help text.

A help consuming user 120 by way of a client computer accesses a graphical user interface (GUI) 105B from a computing application. The help consuming user 120 subsequently submits a help request in association with a region of the GUI 105B. Upon detecting the help request, socialized help logic 170 retrieves the help text authored by the help authoring user 110. Upon retrieving the help text stored in the database 140, socialized help logic 170 renders (displays) the help text 190 in the GUI 105B for the help consuming user 120. Optionally, the displayed help text 190 can be rendered in a separate screen, display, GUI, or user-interface. The help text may be stored in the database 140 according to the coordinates of the designated region of the GUI 105B or matching a specific pattern of pixels in the designated region. Optionally the help text may be associated with the computing application for which the help consuming user 120 submitted the help request for.

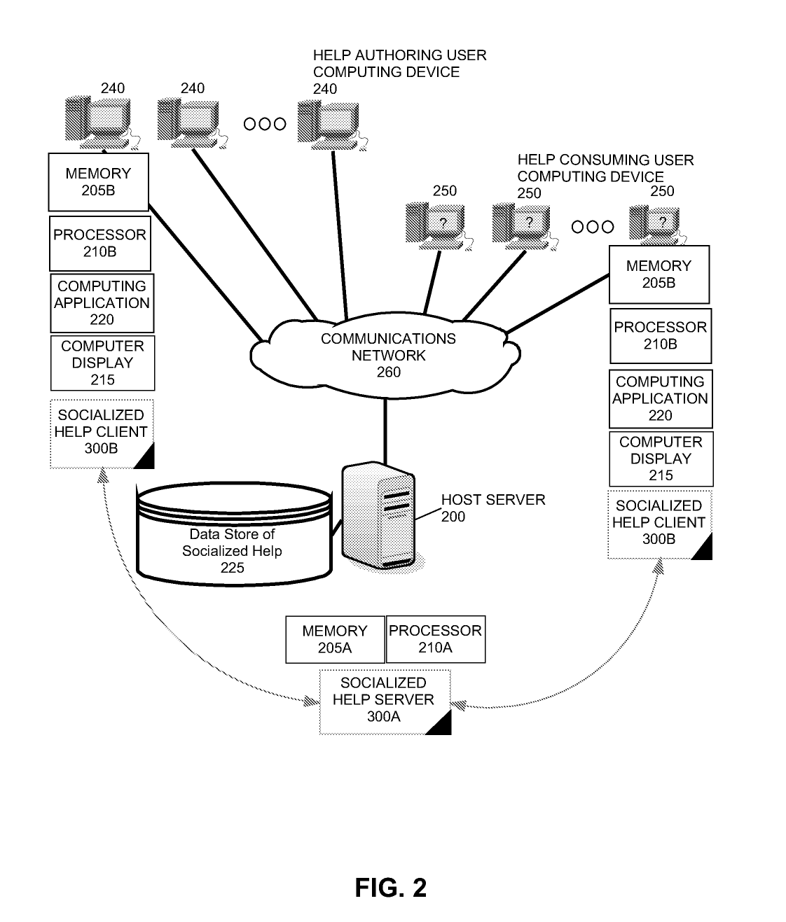

The process described in connection with FIG. 1 can be implemented in a socialized help management system. In further illustration, FIG. 2 is a schematic illustration of a networked computing data processing system configured for managing socialized help. The system can include a host server 200. The host server 200 can include at least one processor 210A and memory 205A supporting the execution of a socialized help server 300A. The socialized help server 300A can communicate over a communications network 260 with a socialized help client 300B. The socialized help server 300A and the socialized help client 300B are configured to execute the socialized help module. The communications network 260 is not limited to a specific type of network but can include Ethernet, Internet, Wireless, 4G, and 3G.

The socialized help module may be executed on any client, including a help authoring user computer device 240 or a help consuming user computing device 250, or both. Each help authoring user computer device 240 and each help consuming user computing device 250 can include at least one processor 210B and memory 205B supporting the operation of a display 215 executing a computing application 220. The help authoring user computing device 240 and the help consuming user computing device are client computers (or clients) to the host server 200 (server), and, thus, the server and clients can communicate via any communications network 260. (For simplicity, the presence of a processor 210B, memory 205B, computing application 220, computer display 215, and socialized help client 300B is only shown once for each type of client computer, but exists for each client.)

A socialized help client 300B executing the socialized help module in memory 205B on the help authoring user computer device 240 or on the help consuming user computing device 250 can be coupled to the computing application 220. The socialized help server 300A and the socialized help client 300B contain the socialized help module that can include program code, which when executed by at least one processor 210A, 210B on the host server 200 or on either user client device 240, 250, respectively, responds to receiving from a help authoring user computing device 240, a specification of a designated region of the GUI. Once the specification, including help text, has been received, the program code can be further enabled to store help text authored by a help authoring user in connection with the designated region in a database or a data store of socialized help 225. Optionally, the stored help text can be subsequently retrieved from the database or data store of socialized help 225 by an authenticated user and modified before being stored again in the database or data store of socialized help 225.

Once the help text has been stored, the program code can be further enabled to detect a help request from a help consuming user computing device 250. In response to detecting the help request from the help consuming user computing device 250, the program code can be enabled to retrieve the help text authored by the help authoring user from the data store of socialized help 225. Finally, upon retrieving the help text, the program code can be further enabled to render the help text in the GUI on the help consuming user computing device 250. Optionally, in response to detecting the help request from the help consuming consumer computing device 250, different help icons in proximity to correspondingly different designated regions in the GUI can be provided indicating available help text for the designated regions in response to detecting the help request by the help consuming user.

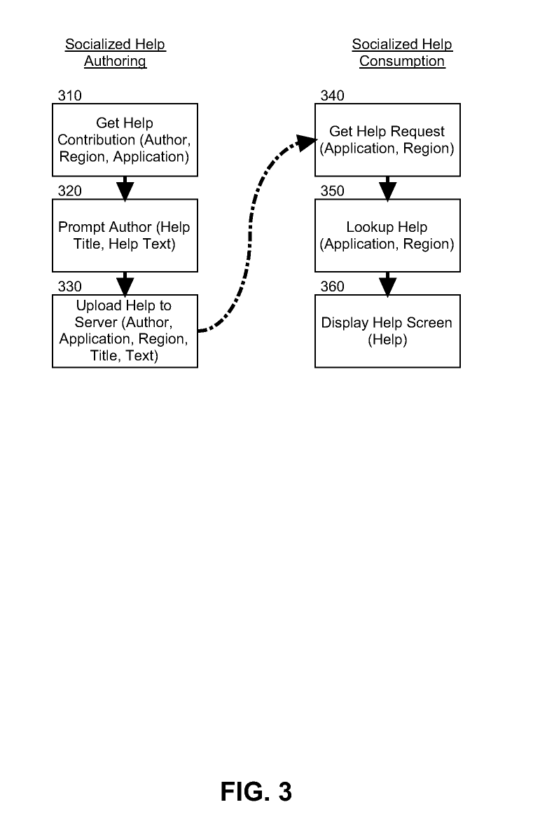

In even yet further illustration of the operating of the program code of the socialized help module, FIG. 3 is a flow chart illustrating a process for managing socialized help in a networked computing application for socialized help authoring and socialized help consumption. Beginning in block 310, a help contribution can be received from a help authoring user. The help contribution can include information pertaining to the help authoring user's identity and region (coordinates) and application, for which the help authoring user is submitting help. In block 320, the help authoring user computing device can be contacted over the Internet and a prompt can be generated and then displayed to the help authoring user for the help authoring user to enter help title and help text. In block 330, the help title and help text along with author, application, and region information can be uploaded to a database coupled to a host server.

In block 340, a help request can be received from a help consuming user containing information pertaining to the help consuming user's in-use application and the region (coordinates) that the help consuming user is seeking help with. In response to getting a help request, a lookup task, using application and region information, is performed in the database to retrieve any stored help information, in block 350. In block 360, the authored help, including the help title and help text is displayed for the help consuming user upon retrieving the stored help information.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, with a specific field of a graphical user interface (GUI), the specific field having specific coordinates components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for managing socialized help in a networked computing application, the method comprising:
receiving from a help authoring user in a graphical user interface (GUI) rendered for the help authoring user in a display of a computing application executing in a client computer with at least one processor and memory, a specification of a designated region of the GUI;
storing help text authored by the help authoring user in connection with the designated region;
detecting a help request by a help consuming user in association with a region of a GUI rendered for the help consuming user and corresponding to the designated region;
retrieving the help text authored by the help authoring user in connection with the designated region; and,
rendering the help text in the GUI rendered for the help consuming user.

2. The method of claim 1, wherein storing help text authored by the help authoring user in connection with the designated region, comprises:
uploading the help text to a host server.

3. The method of claim 1, wherein the help text includes a help title.

4. The method of claim 1, further comprising storing in connection with the help text an identity of the help authoring user, the designated region, and a title of the computing application.

5. The method of claim 4, wherein retrieving the help text authored by the help authoring user in connection with the designated region, comprises:
performing a lookup in a database using the title of the computing application and the designated region.

6. The method of claim 1, wherein rendering the help text in the GUI rendered for the help consuming user, comprises:
displaying the help text on the display of the client computer.

7. The method of claim 1, further comprising:
providing different help icons in proximity to correspondingly different designated regions in the GUI indicating available help text for the designated regions in response to detecting the help request by the help consuming user.

8. The method of claim 1, further comprising:
selecting help text authored by the help authoring user in connection with a designated region in the database;
modifying the help text; and,
storing the modified help text in the database.

9. A computer program product for managing socialized help, the computer program product comprising:
a computer readable storage medium having computer readable program code embodied therewith, the computer readable program code comprising:
computer readable program code for receiving from a help authoring user in a graphical user interface (GUI) rendered for the help authoring user in a display of a computing application executing in a client computer with at least one processor and memory, a specification of a designated region of the GUI;
computer readable program code for storing help text authored by the help authoring user in connection with the designated region;
computer readable program code for detecting a help request by a help consuming user in association with a region of a GUI rendered for the help consuming user and corresponding to the designated region;
computer readable program code for retrieving the help text authored by the help authoring user in connection with the designated region; and,
computer readable program code for rendering the help text in the GUI rendered for the help consuming user.

10. The computer program product of claim 9, wherein the computer readable program code for storing help text authored by the help authoring user in connection with the designated region, comprises:
computer readable program code for uploading the help text to a host server.

10. The computer program product of claim 9, wherein the help text includes a help title.

12. The computer program product of claim 9, further comprising computer readable program code for storing in connection with the help text an identity of the help authoring user, the designated region, and a title of the computing application.

13. The computer program product of claim 12, wherein the computer readable program code for retrieving the help text authored by the help authoring user in connection with the designated region, comprises:
computer readable program code for performing a lookup in a database using the title of the computing application and the designated region.

14. The computer program product of claim 9, wherein the computer readable program code for rendering the help text in the GUI rendered for the help consuming user, comprises:
computer readable program code for displaying the help text on the display of the client computer.

15. The computer program product of claim 9, further comprising:
computer readable program code for providing different help icons in proximity to correspondingly different designated regions in the GUI indicating available help text for the designated regions in response to detecting the help request by the help consuming user.

16. The computer program product of claim 9, further comprising:
computer readable program code for selecting help text authored by the help authoring user in connection with a designated region in the database;
computer readable program code for modifying the help text; and,
computer readable program code for storing the modified help text in the database.

17. A socialized help management system comprising:
a client computer configured for communicative coupling to a host server and a database;
a display coupled to the client computer;
a computing application executing in the client computer; and,
a socialized help module coupled to the computing application, the module comprising program code enabled when executing in the computer to receive from a help authoring user in a graphical user interface (GUI) rendered for the help authoring user in the display, a specification of a designated region of the GUI, to store help text authored by the help authoring user in connection with the designated region in the database, to detect a help request by a help consuming user in association with a region of a GUI rendered for the help consuming user and corresponding to the designated region, to retrieve the help text authored by the help authoring user in connection with the designated region from the database, and to render the help text in the GUI rendered for the help consuming user.

18. The system of claim 17, wherein the designated region is pixel pattern dynamically matchable to a region of the GUI.
